(19) United States
(12) Patent Application Publication
(10) Pub. No.: US 2026/0280219 A1
(43) Pub. Date: Sep. 17, 2026

(54) TUNABLE THERMO-OPTIC FIBER DELAY FOR COHERENT BEAM COMBINING

(71) Applicant: Lumentum Operations LLC, San Jose, CA (US)

(72) Inventors: Benedikt HERMANN, Zurich (CH); Peter JAKOPIC, Videm-Dobrepolje (SI); Žan PIRNAR, Ljubljana (SI)

(21) Appl. No.: 19/222,242

(22) Filed: May 29, 2025

Related U.S. Application Data
(60) Provisional application No. 63/771,991, filed on Mar. 14, 2025.

(51) Int. Cl. H01S 3/04; H01S 3/067; H01S 3/094; H01S 3/10; H01S 3/13; H01S 3/23

(52) U.S. Cl. CPC H01S 3/0401; H01S 3/06754; H01S 3/094007; H01S 3/10092; H01S 3/1305; H01S 3/2383

(57) ABSTRACT

A coherent beam combining system includes a plurality of thermal delay optical fibers, each thermal delay optical fiber arranged on a respective optical channel of a plurality of optical channels, and each thermal delay optical fiber including light-absorbing elements configured to absorb intensity-controlled pump light to convert the intensity-controlled pump light into a corresponding quantity of heat, thereby causing a controlled temperature within the thermal delay optical fiber corresponding to an intensity of the intensity-controlled pump light. A plurality of heater pump light sources are respectively coupled to the plurality of thermal delay optical fibers. Each heater pump light source is configured to inject the intensity-controlled pump light into a respective thermal delay optical fiber of the plurality of thermal delay optical fibers for regulating the controlled temperature within the respective thermal delay optical fiber. A beam combiner combines a plurality of amplified beamlets into a coherently-combined amplified beam.

### CROSS-REFERENCE TO RELATED APPLICATION

This Patent application claims priority to U.S. Provisional Patent Application No. 63/771,991, filed on Mar. 14, 2025, and entitled “TUNABLE THERMO-OPTIC FIBER DELAY FOR COHERENT BEAM COMBINING.” The disclosure of the prior Application is considered part of and is incorporated by reference into this Patent Application.

### TECHNICAL FIELD

The present disclosure relates generally to a coherent beam combining scheme and to utilizing tunable thermo-optic fiber delays for phase and group delay control in a coherent beam combining system.

### BACKGROUND

Fiber laser technology has provided a versatile and reliable approach to laser source manufacturing with a wide range of applications. Power/energy scaling of single-fiber laser systems with serial amplifiers has faced several fundamental limitations. In particular, energy scaling of ultra-fast lasers with pulse durations in a picosecond or femtosecond range with serial amplifiers has reached fundamental limits in terms of output power. In addition, non-linear intensity effects, including self-phase modulation and Kerr lensing, cause beam degradation.

Combining output powers of multiple laser amplifiers is an approach to overcome the fundamental limitations of single-fiber laser systems and to boost a power/energy level of a laser. One approach to overcome single-amplifier limitations is coherent beam combining. Coherent beam combining of fiber amplification channels may be used for generating ultra-high-power/energy lasers. Coherent beam combining is a technique of power scaling by combining multiple laser amplifiers, which are seeded by a common source, into a single high-power beam while maintaining beam quality. In addition to spatial properties, coherent beam combining preserves the spectral properties of the lasers. Additionally, there is a phase relation between parallel laser amplifiers (e.g., fiber gain amplifiers) such that the parallel laser amplifiers are operating effectively as a single laser.

### SUMMARY

In some implementations, a coherent beam combining system includes a seed light source configured to generate pulsed seed light comprising a plurality of pulses; a beam splitter configured to split the pulsed seed light into a plurality of beamlets, and provide the plurality of beamlets to a plurality of optical channels, wherein each beamlet of the plurality of beamlets is provided to a respective optical channel of the plurality of optical channels; a plurality of thermal delay optical fibers, wherein each thermal delay optical fiber of the plurality of thermal delay optical fibers is arranged on a respective optical channel of the plurality of optical channels, wherein each thermal delay optical fiber of the plurality of thermal delay optical fibers includes one or more light-absorbing elements configured to absorb intensity-controlled pump light to convert the intensity-controlled pump light into a corresponding quantity of heat, thereby causing a controlled temperature within the thermal delay optical fiber corresponding to an intensity of the intensity-controlled pump light; a plurality of heater pump light sources respectively coupled to the plurality of thermal delay optical fibers, wherein each heater pump light source of the plurality of heater pump light sources is configured to inject the intensity-controlled pump light into a respective thermal delay optical fiber of the plurality of thermal delay optical fibers for regulating the controlled temperature within the respective thermal delay optical fiber; a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels; and a beam combiner configured to combine the plurality of amplified beamlets into a coherently-combined amplified beam.

In some implementations, a coherent beam combining system includes a seed light source configured to generate pulsed seed light comprising a plurality of pulses; a beam splitter configured to split the pulsed seed light into a plurality of beamlets, and provide the plurality of beamlets to a plurality of optical channels, wherein each beamlet of the plurality of beamlets is provided to a respective optical channel of the plurality of optical channels; a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels, and wherein each amplifier optical fiber of the plurality of amplifier optical fibers includes one or more light-absorbing elements configured to absorb intensity-controlled pump light to convert the intensity-controlled pump light into a corresponding quantity of heat, thereby causing a controlled temperature within the amplifier optical fiber corresponding to an intensity of the intensity-controlled pump light; a plurality of heater pump light sources respectively coupled to the plurality of amplifier optical fibers, wherein each heater pump light source of the plurality of heater pump light sources is configured to inject the intensity-controlled pump light into a respective amplifier optical fiber of the plurality of amplifier optical fibers for regulating the controlled temperature within the respective amplifier optical fiber; and a beam combiner configured to combine the plurality of amplified beamlets into a coherently-combined amplified beam.

In some implementations, a coherent beam combining system includes a seed light source configured to generate seed light; a beam splitter configured to split the seed light into a plurality of beamlets, and provide the plurality of beamlets to a plurality of optical channels, wherein each beamlet of the plurality of beamlets is provided to a respective optical channel of the plurality of optical channels; a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels, and wherein each amplifier optical fiber of the plurality of amplifier optical fibers includes one or more light-absorbing elements configured to absorb intensity-controlled pump light to convert the intensity-controlled pump light into a corresponding quantity of heat, thereby causing a controlled temperature within the amplifier optical fiber corresponding to an intensity of the intensity-controlled pump light; a plurality of pump light sources respectively coupled to the plurality of amplifier optical fibers, wherein each pump light source of the plurality of pump light sources is configured to inject the intensity-controlled pump light into a respective amplifier optical fiber of the plurality of amplifier optical fibers for amplifying a respective beamlet of the plurality of beamlets and for regulating the controlled temperature within the respective amplifier optical fiber; and a beam combiner configured to combine the plurality of amplified beamlets into a coherently-combined amplified beam.

### BRIEF DESCRIPTION OF THE DRAWINGS

FIG. 1A shows a coherent beam combiner system according to one or more embodiments.

FIG. 1B shows a coherent beam combiner system according to one or more embodiments.

FIG. 1C shows a coherent beam combiner system according to one or more embodiments.

FIG. 2A shows a cross-section of a thermal delay optical fiber according to one or more implementations.

FIG. 2B shows a cross-section of a thermal delay optical fiber according to one or more implementations.

FIG. 2C shows a cross-section of a thermal delay optical fiber according to one or more implementations.

FIG. 3 shows a cross-section of an amplifier optical fiber with thermal delay functionality according to one or more implementations.

### DETAILED DESCRIPTION

The following detailed description of example implementations refers to the accompanying drawings. The same reference numbers in different drawings may identify the same or similar elements.

For coherent beam combining, a seed laser is split up into several laser replicas or beamlets (e.g., N laser channels), the laser beamlets are amplified by the parallel laser amplifiers to a highest possible power/energy through amplifier sections of the parallel laser amplifiers, and the amplified laser beamlets are combined into a high-brightness single beam (e.g., into a (re) combined laser beam). The seed laser may be pulsed seed light that includes a plurality of pulses that are sequentially transmitted. Thus, each laser beamlet is also a pulsed light beam. To realize coherent beam combining, the phase of each laser channel should be locked by either passive or active mechanisms. A portion of the combined laser beam may be split off by a beam splitter and used as a feedback signal for optical delay monitoring and/or phase monitoring. Thus, coherent beam combining may include beam splitting of seed light into beamlets, group delay control, phase control, parallel amplification, and recombination of amplified beamlets.

Group delay control is used for ultra-fast pulses to ensure matching arrival times of individual laser channels (beamlets). In other words, group delay control may be used to ensure that corresponding pulses of the beamlets arrive at the same time at the beam combiner in order to maximize the optical power of the combined laser beam (e.g., to maximize the optical power of a recombined pulse). “Corresponding pulses” may refer to pulses of the beamlets that originate from or correspond to a same source pulse of the seed laser. The source pulse may be split into the corresponding pulses when splitting the seed laser into the beamlets. Ideally, the beamlets should be matched in phase and group delay such that the corresponding pulses of the are phase-aligned with matched arrival times at the beam combiner.

Matching arrival times may be used to compensate for fabrication tolerances (static delay mismatches). In addition, thermal gradients among amplifier channels can lead to group delay mismatch (varying with pump power). Group delay mismatch is of particular importance for multi-core fibers (MCFs) with a non-circular symmetric arrangement of cores. In this case, a temperature induced by a pump light absorption varies among the cores of the MCFs. A variance in temperature may cause a group delay mismatch at the amplifier channels, which may cause corresponding pulses to arrive at the beam combiner at different arrival times. Thus, phase control is important for ensuring constructive interference among the beamlets at the output (e.g., at the beam combiner). Additionally, once group delay is ensured (matching arrival time), phase matching needs to be ensured as well. Continuous feedback at a kHz-level is typically needed to achieve stable output power.

Technically, group delay and phase control are acting on a same property (e.g., a temporal delay) of the laser pulses on different time scales. Group delay from fabrication variance of amplifier channel optical path lengths may be controlled to a fraction (e.g., one-tenth) of a pulse length. Phase delay may be controlled to a fraction (e.g., one-tenth) of a wavelength.

Free-space delay control systems exist in multiple free-space configurations, such as mirrors on moving linear stages, a piezo mirror array, a micro-electromechanical system (MEMS) mirror array, a spatial light modulator (SLM), and electro-optic modulators (EOMs). Each free-space configuration has one or more drawbacks, including slow response times (e.g., applicable to linear stages and SLMs), bulkiness and poor scalability (e.g., applicable to linear stages and EOMs), limited delay range (e.g., applicable to piezo mirror arrays, MEMS mirror arrays, and EOMs), and robustness and vibration tolerance (e.g., applicable to all free-space configurations).

Some implementations disclosed herein provide a delay line solution for a coherent beam combiner that is entirely fiber-based. Each parallel laser channel may include a thermal delay fiber used to control a delay in the parallel laser channel. The delay is adjusted by controlling the temperature of a fiber core of the thermal delay fiber. Thus, the delay imposed by each thermal delay fiber may be controlled independently. To control the temperature, and thus the delay, of a thermal delay fiber, a pump diode heater may be coupled to an input of the thermal delay fiber. The pump diode heater may inject pump light into the thermal delay fiber to control the temperature. Heat is generated within a thermal delay fiber by absorbing atoms of the pump light distributed within the thermal delay fiber, converting pump light to heat. The pump light used for heating should have a wavelength that is different from the wavelength of a signal light (e.g., the wavelength of seed light) that is also being injected into the input of the thermal delay fiber. For example, the pump light may be injected into a pump cladding of the thermal delay fiber, whereas signal light may be injected into a core of the thermal delay fiber. Sufficient transparency at the signal wavelength should be maintained.

Generating heat within a thermal delay fiber enables faster control bandwidth than an external heating system, due to thermal transport time τ scaling with

$${l}^{2} = ( τ = \frac{{l}^{2}}{D} ,$$

where D: diffusivity constant and l: characteristic length).

Thus, one or more coherent beam combiners described herein avoid free-space delay control for a fiber-based coherent beam combiner system, thereby increasing robustness. In addition, an all-fiber solution can be shielded better from external environmental effects, such as vibration, humidity, and temperature. Moreover, using thermal delay fibers may improve a delay range in each laser channel, which may lead to better delay matching and compensation.

The design of the thermal delay fibers may be customized, with absorbents distributed in a pump cladding for heating. Thus, the pump light may interact with the absorbents that are distributed in the pump cladding of the thermal delay fibers, with the absorption of the pump light by the absorbents converting the pump light into heat. An intensity of the pump light may be controlled to regulate the temperature of the thermal delay fiber, which regulates the delay of signal light in the core. For example, the intensity of the pump light may be proportional to the temperature within the thermal delay fiber, with a change in the intensity causing a proportional change in temperature within the thermal delay fiber.

The length of a thermal delay fiber affects an achievable tuning range for the optical path length (OPL), or effective optical path length, of the thermal delay fiber. The range of each thermal delay fiber should exceed the OPL differences of the overall system channels such that each thermal delay fiber is capable of compensating for a wide delay range, including any OPL difference in the coherent beam combiner system. Thus, a length L of a thermal delay fiber may be represented by the following inequality:

$$L > {OPL}_{System} \div ( \frac{d n}{d T} \cdot Δ {T}_{max} )$$

where OPL_{System} denotes OPL variation within the system channels, dn/dT denotes a thermo-optic coefficient of a thermal delay fiber, and ΔTₘₐₓ denotes a maximum achievable temperature increase of a thermal delay fiber. If the thermal delay fiber is heated inhomogeneously, ΔTₘₐₓ is the maximum achievable averaged temperature increase over the entire heated thermal delay fiber.

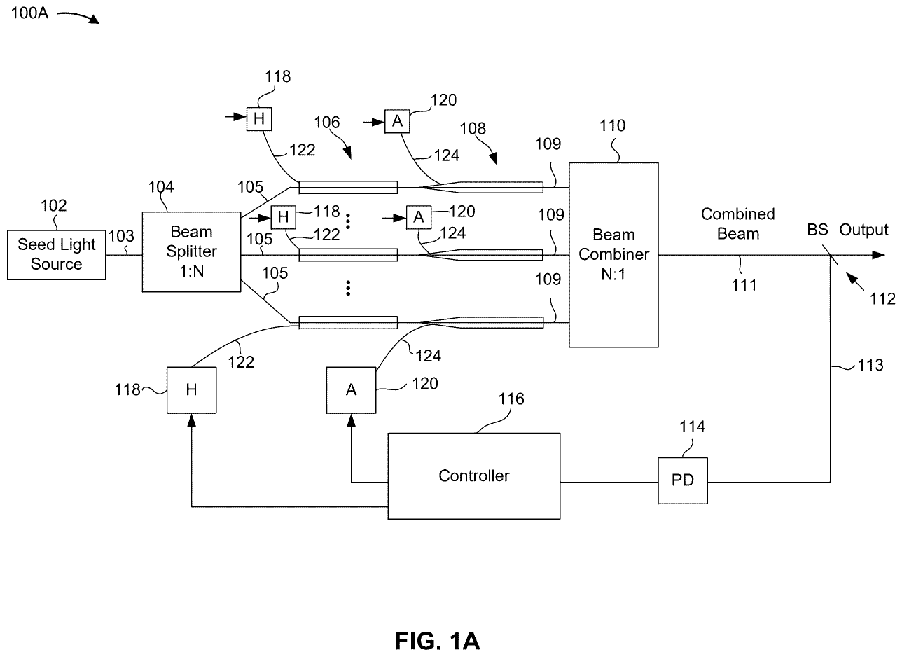

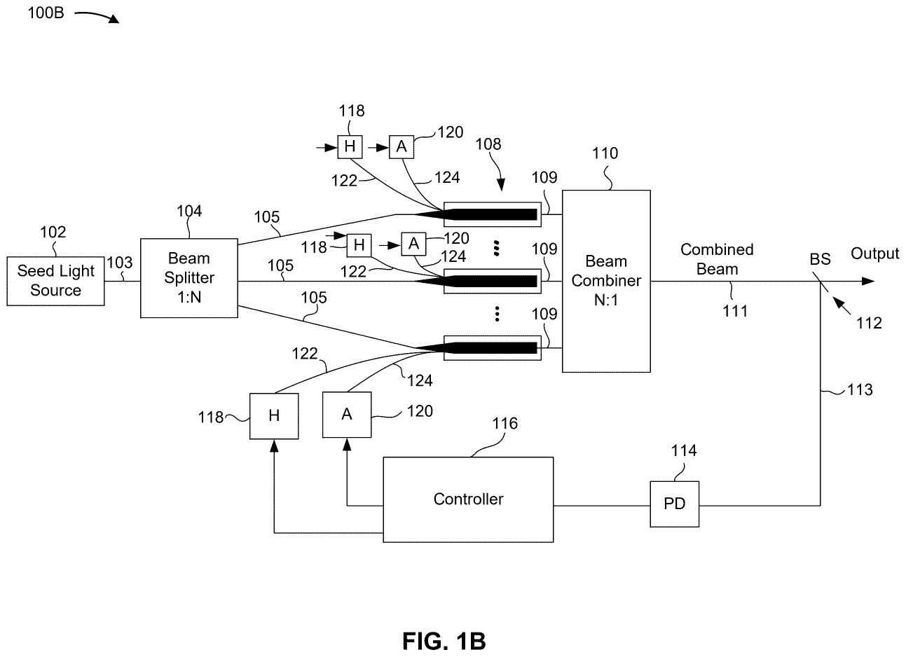

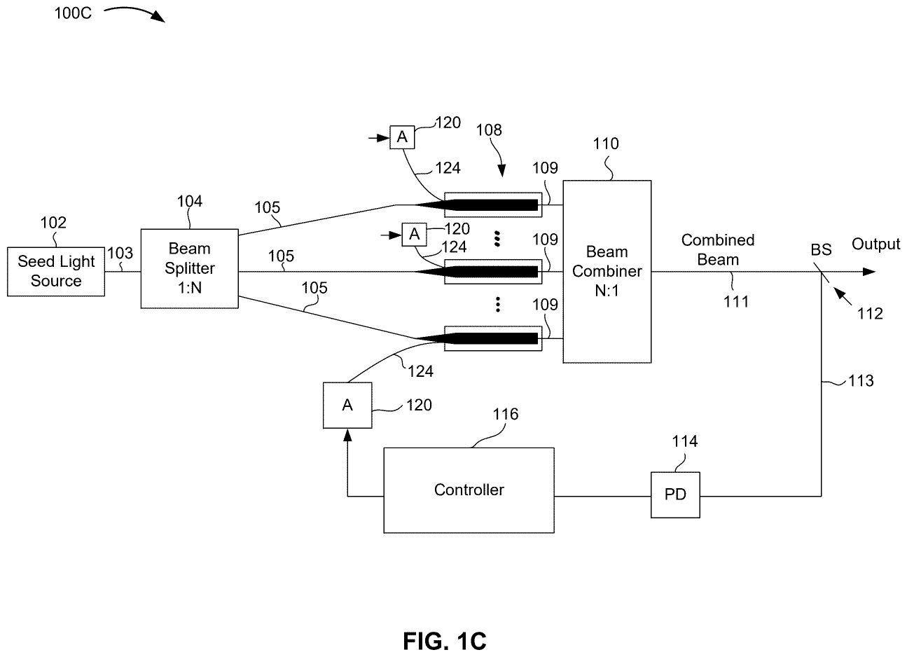

FIG. 1A shows a coherent beam combiner system 100A according to one or more embodiments. The coherent beam combiner system 100A may include a seed light source 102, a beam splitter 104, a plurality of thermal delay optical fibers 106, a plurality of amplifier optical fibers 108, a beam combiner 110, a feedback beam splitter 112, a photodetector 114, a controller 116, a plurality of heater pump light sources 118, and a plurality of amplifying pump light sources 120.

The seed light source 102 may generate pulsed seed light 103 comprising a plurality of pulses. For example, the seed light source 102 may generate a sequence of light pulses, and transmit the sequence of light pulses on an optical path. The optical path of the coherent beam combiner system 100A may be entirely fiber-based. The optical path may extend from the seed light source 102 to an output of the feedback beam splitter 112.

The beam splitter 104 may split the pulsed seed light 103 into a plurality of beamlets 105 (e.g., N beamlets, where N is an integer greater than one), and provide the plurality of beamlets 105 to a plurality of optical channels. Thus, each beamlet of the plurality of beamlets 105 is provided to a respective optical channel of the plurality of optical channels. The plurality of optical channels are parallel optical channels that are coupled between the beam splitter 104 and the beam combiner 110. Each optical channel includes a respective thermal delay optical fiber 106 and a respective amplifier optical fiber 108.

Each thermal delay optical fiber of the plurality of thermal delay optical fibers 106 is arranged on a respective optical channel of the plurality of optical channels. In addition, each thermal delay optical fiber of the plurality of thermal delay optical fibers may include one or more light-absorbing elements configured to absorb intensity-controlled pump light 122 to convert the intensity-controlled pump light 122 into a corresponding quantity of heat, thereby causing a controlled temperature within the thermal delay optical fiber corresponding to an intensity of the intensity-controlled pump light. The controlled temperature within the thermal delay optical fiber may be adjusted by adjusting the intensity of the intensity-controlled pump light. For example, the controlled temperature within the thermal delay optical fiber may be proportional to the intensity of the intensity-controlled pump light. A time delay and/or phase delay through the thermal delay optical fiber may be proportional or otherwise related to the controlled temperature within the thermal delay optical fiber. Thus, controlling a pump intensity enables delay control through the thermal delay optical fiber via a thermo-optic effect. In some cases, the intensity-controlled pump light 122 may be referred to as heater pump light.

The plurality of amplifier optical fibers 108 may amplify the plurality of beamlets 105 to generate a plurality of amplified beamlets 109. For example, each amplifier optical fiber of the plurality of amplifier optical fibers 108 may be arranged on a respective optical channel of the plurality of optical channels for amplifying a respective beamlet.

The beam combiner 110 configured to combine the plurality of amplified beamlets 109 into a coherently-combined amplified beam 111, and provide the coherently-combined amplified beam 111 to the output of the coherent beam combiner system 100A.

The plurality of heater pump light sources 118 are respectively coupled to the plurality of thermal delay optical fibers 106. Thus, each heater pump light source of the plurality of heater pump light sources 118 may inject the intensity-controlled pump light 122 into a respective thermal delay optical fiber of the plurality of thermal delay optical fibers 106 for regulating the controlled temperature within the respective thermal delay optical fiber. For example, the controlled temperature within a respective thermal delay optical fiber may be regulated by regulating an intensity of the intensity-controlled pump light 122 injected into the respective thermal delay optical fiber. The plurality of heater pump light sources 118 and the plurality of thermal delay optical fibers 106 may be respectively coupled by optical fibers (e.g., by optical fibers of a pump-signal combiner) that guide the intensity-controlled pump light 122 from the heater pump light sources 118 to the thermal delay optical fibers 106.

In some implementations, the plurality of heater pump light sources 118 may inject the intensity-controlled pump light 122 into the plurality of thermal delay optical fibers 106 at respective intensities such that corresponding pulses of the plurality of amplified beamlets 109 have matched arrival times at the beam combiner 110. The output power of the plurality of heater pump light sources 118 may be individually controlled by the controller 116 to control the intensity of the intensity-controlled pump light 122 generated by each heater pump light sources 118. Thus, the plurality of heater pump light sources 118 may inject the intensity-controlled pump light 122 into the plurality of thermal delay optical fibers 106 at respective intensities such that the plurality of amplified beamlets 109 have a matched phase at the beam combiner 110. Additionally, or alternatively, the plurality of heater pump light sources 118 may inject the intensity-controlled pump light 122 into the plurality of thermal delay optical fibers 106 at respective intensities such that the plurality of amplified beamlets 109 combine with a substantially maximum constructive interference at the beam combiner 110.

The plurality of amplifying pump light sources 120 may be respectively coupled to the plurality of amplifier optical fibers 108. Thus, each amplifying pump light source of the plurality of amplifying pump light sources 120 may inject amplifying pump light 124 into a respective amplifier optical fiber of the plurality of amplifier optical fibers 108 for amplifying a respective beamlet of the plurality of beamlets 105. For example, each amplifier optical fiber of the plurality of amplifier optical fibers 108 may include a core and first dopants arranged in the core. The first dopants may be configured to absorb a wavelength for the amplifying pump light 124, converting the amplifying pump light 124 into a stimulated emission for amplifying the respective beamlet. In some implementations, the first dopants may be rare-earth element dopants that convert the amplifying pump light 124 into signal light (e.g., laser light) as the amplifying pump light 124 interacts with the core (e.g., with the first dopants) of the amplifier optical fiber.

In some implementations, the seed light source 102 may generate the pulsed seed light 103 at a first wavelength. Additionally, the plurality of heater pump light sources 118 may generate the intensity-controlled pump light 122 at a second wavelength that is different from the first wavelength. The one or more light-absorbing elements in each of the thermal delay optical fibers 106 may be configured to absorb the second wavelength and not absorb the first wavelength. As a result, only the intensity-controlled pump light 122 is converted to heat by the one or more light-absorbing elements.

In some implementations, the one or more light-absorbing elements in each of the thermal delay optical fibers 106 are dopants (e.g., second dopants) distributed within a cladding or within a core of the thermal delay optical fiber, the dopants being configured to absorb the second wavelength.

In some implementations, the one or more light-absorbing elements in each of the thermal delay optical fibers 106 are polarization-maintaining stress rods arranged within a cladding of the thermal delay optical fiber. The polarization-maintaining stress rods may be doped with dopants (e.g., second dopants) configured to absorb the second wavelength.

In some implementations, the one or more light-absorbing elements in each of the thermal delay optical fibers 106 include an absorber ring arranged within a cladding of the thermal delay optical fiber and encircling a core of the thermal delay optical fiber. The absorber ring may be doped with dopants (e.g., second dopants) configured to absorb the second wavelength.

In some implementations, the one or more light-absorbing elements in each of the thermal delay optical fibers 106 are absorber rods arranged within a cladding of the thermal delay optical fiber. The absorber rods may be doped with dopants (e.g., second dopants) configured to absorb the second wavelength.

In some implementations, the plurality of thermal delay optical fibers 106 may be arranged upstream from the plurality of amplifier optical fibers, as shown in FIG. 1A. Accordingly, the plurality of thermal delay optical fibers 106 may guide the plurality of beamlets 105 from the beam splitter 104 to the plurality of amplifier optical fibers 108. Additionally, the plurality of thermal delay optical fibers 106 may thermally-control phases and time delays of the plurality of beamlets 105 such that corresponding pulses of the plurality of amplified beamlets 109 are phase-aligned with matched arrival times at the beam combiner 110. Each thermal delay optical fiber of the plurality of thermal delay optical fibers 106 may induce a controlled delay on a respective beamlet of the plurality of beamlets 105 based on the controlled temperature within the thermal delay optical fiber.

In some implementations, the plurality of thermal delay optical fibers 106 may be arranged downstream from the plurality of amplifier optical fibers 108. Accordingly, the plurality of thermal delay optical fibers 106 may guide the plurality of amplified beamlets 109 from the plurality of amplifier optical fibers 108 to the beam combiner 110. Additionally, the plurality of thermal delay optical fibers 106 may thermally-control phases and time delays of the plurality of amplified beamlets 109 such that corresponding pulses of the plurality of amplified beamlets 109 are phase-aligned with matched arrival times at the beam combiner 110. Each thermal delay optical fiber of the plurality of thermal delay optical fibers 106 may induce a controlled delay on a respective amplified beamlet of the plurality of amplified beamlets 109 based on the controlled temperature within the thermal delay optical fiber.

The controller 116 may be a feedback controller configured to individually control the intensity of the intensity-controlled pump light 122 from each heater pump light source of the plurality of heater pump light sources 118 such that corresponding pulses of the plurality of amplified beamlets 109 are phase-aligned with matched arrival times at the beam combiner 110. For example, the feedback beam splitter 112 may split a feedback portion 113 of the coherently-combined amplified beam 111 from an output path. The photodetector 114 may convert the feedback portion 113 into an electrical measurement signal (e.g., a voltage). In some implementations, the photodetector 114 may be part of the controller 116. The controller 116 may receive the feedback portion or a measurement value thereof, and adjust one or more intensities of the intensity-controlled pump light 122 from the plurality of heater pump light sources 118 such that corresponding pulses of the plurality of amplified beamlets 109 are phase-aligned with matched arrival times at the beam combiner 110. The controller 116 may also control the amplifying pump light sources 120.

To maintain transparency for the pulsed seed light 103, the dopants for heat generation should not absorb the signal wavelength of the pulsed seed light 103 or should be located outside a signal perimeter. Fastest response times are achieved when a heat source (e.g., the absorbers) is confined to a target region (e.g., the core). Thus, the heat source should be provided sufficiently close to the core to accurately change a temperature of the core to a desired temperature to effect a desired change in refractive index.

Each thermal delay optical fiber may be pumped (heated) by a fiber-coupled light source (e.g., a pump source) via a pump-signal combiner. A thermal delay optical fiber may doped with atoms (e.g., second dopants) that absorb a wavelength of the fiber-coupled light source (e.g., a wavelength of the pump light). Controlling a pump intensity of the fiber-coupled light source enables delay control via a thermo-optic effect. For example, a change in temperature caused by pump light absorption causes a refractive index to change, which causes an effective optical path length of the thermal delay optical fiber to change, which causes a delay (or propagation time through the thermal delay optical fiber) to change. A change in effective optical path length (ΔOPL) may be represented by the following equation:

$$Δ OPL = L \cdot Δ n = L \cdot \frac{d n}{d T} \cdot Δ T$$

where Δn denotes a change in refractive index of the thermal delay optical fiber, L denotes fiber length,

$$\frac{dn}{dT}$$

denotes a thermo-optic coefficient of the thermal delay optical fiber, and ΔT denotes a temperature change of the thermal delay optical fiber. If the thermal delay optical fiber is heated inhomogeneously, ΔT is a maximum averaged temperature change over an entire length of the thermal delay optical fiber.

An estimation on response times is provided according to an example. In this example, a core diameter affects an achievable speed by tc=L²/alpha, where tc denotes a time constant, alpha denotes a thermal diffusivity, and L denotes characteristic length. In this example, alpha is 0.8×10\hat{ }-6 m²/s for glass and L is 10 μm. Accordingly, tc is equal to 125 μs, corresponding to 8 kHz. Achieving faster heating response times may be possible when the heating is performed inside the core, as opposed to in the pump cladding.

An estimation on temperature changes is provided according to an example. The thermo-optic coefficient dn/dT describes how a refractive index varies with temperature. A typical value in glass includes dn/dT=10⁻⁵ K⁻¹. Accordingly, to achieve a delay difference of 0.1 mm in a 1.0 m long fiber, a temperature difference of 10 Kelvin (K) is required.

In some implementations, the thermal delay optical fibers may be embedded in a cooling environment for efficient and fast cooling. For example, the thermal delay optical fibers may be potted into tight grooves of a metal cold plate.

Design parameters for a thermal delay fiber may include core diameter, length, dopant(s), dopant concentration, dopant location, cooling environment, and heater pump light wavelength. The core diameter may be designed to configure thermal response time and delay efficiency (e.g., OPL and heater power). The length may be designed to configure achievable OPL (e.g., effective OPL). The dopant(s) may be selected for maintaining transparency for signal light (if dopants are applied to the core), and for configuring heater wavelength (not affecting amplification), tuning the thermo-optic coefficient dn/dT, and tuning absorption. The dopant concentration may be selected to configure a temperature profile (heat profile) along the thermal delay fiber, achievable OPL, and tuning the thermo-optic coefficient dn/dT. The dopant location may be designed to configure achievable control speed and bandwidth, and to avoid disturbance of the signal light. The cooling environment, such as potting, may be designed to configure achievable OPL, and to provide environmental stability and robustness. The heater pump light wavelength may be selected to ensure independent action of delay and amplification, and to control a temperature profile based on absorption, attenuation, and scattering.

The design parameters may enable a large potential operating range for a thermal delay fiber to achieve a desired performance for a fiber-based coherent beam combiner system.

In cases in which there are long group delays (e.g., orders of magnitude larger than the signal wavelength of the of the pulsed seed light 103), a splitting of group delay and phase delay capabilities might be preferred. This can be implemented by two heater light pumps, two dopants, and/or two separate thermal delay fiber sections. In other words, each channel may include two thermal delay fibers in series or two sections of a same thermal delay fiber in series, where one thermal delay fiber or one section compensates for the group delay, and the other thermal delay fiber or the other section compensates for the phase delay. Each thermal delay fiber or section of a channel may have a respective heater light pump for pump light and respective dopants for opto-thermal conversion. Using two in-series thermal delay fibers or two in-series sections may loosen requirements on the heater light pumps in terms of range and noise.

As indicated above, FIG. 1A is provided merely as an example. Other examples may differ from what is described with regard to FIG. 1A.

FIG. 1B shows a coherent beam combiner system 100B according to one or more embodiments. The coherent beam combiner system 100B may be similar to the coherent beam combiner system 100A described in connection with FIG. 1A. However, in the coherent beam combiner system 100B, the thermal delay optical fibers 106 and the amplifier optical fibers 108 may be combined. In other words, aspects of the thermal delay optical fibers 106 described in connection with FIG. 1A may be integrated into the amplifier optical fibers 108 of the plurality of optical channels to control a delay through each amplifier optical fiber. Thus, each amplifier optical fiber may have one or more thermal delay features integrated therein.

In this case, a first fiber-coupled light source for heating (e.g., a pump source for intensity-controlled pump light 122) and a second fiber-coupled light source for amplification (e.g., a pump source for amplifier pump light 124) are coupled to an amplifier optical fiber to inject respective pump light into the amplifier optical fiber. For example, the first fiber-coupled light source (e.g., a heater pump light sources 118) and the second fiber-coupled light source (e.g., an amplifying pump light source 120) may be coupled to opposite sides of the amplifier optical fiber 108 or may be coupled to a same side of the amplifier optical fiber 108 by a 2×1+1 combiner. In this case, wavelength selection of the intensity-controlled pump light 122 and the amplifier pump light 124, and dopant selection within the amplifier optical fiber for opto-thermal conversion and light amplification, are important to ensure that signal light amplification and thermal delay control act independently. For example, the wavelength of the intensity-controlled pump light 122 should not affect signal amplification to ensure constant output power for each beamlet through each amplifier optical fiber. Accordingly, the intensity-controlled pump light 122 and the amplifier pump light 124 may have different wavelengths. Additionally, dopants for absorbing the intensity-controlled pump light 122 may be different from dopants (e.g., gain medium dopants) used for signal amplification.

Accordingly, the seed light source 102 may generate pulsed seed light 103 comprising a plurality of pulses. For example, the seed light source 102 may generate a sequence of light pulses, and transmit the sequence of light pulses on an optical path. The optical path of the coherent beam combiner system 100A may be entirely fiber-based. The optical path may extend from the seed light source 102 to an output of the feedback beam splitter 112.

The beam splitter 104 may split the pulsed seed light 103 into a plurality of beamlets 105 (e.g., N beamlets), and provide the plurality of beamlets 105 to a plurality of optical channels. Thus, each beamlet of the plurality of beamlets 105 is provided to a respective optical channel of the plurality of optical channels. The plurality of optical channels are parallel optical channels that are coupled between the beam splitter 104 and the beam combiner 110. Each optical channel includes a respective amplifier optical fiber 108 with integrated thermal-delay control.

The plurality of amplifier optical fibers 108 may amplify the plurality of beamlets 105 to generate a plurality of amplified beamlets 109. Each amplifier optical fiber of the plurality of amplifier optical fibers 108 is arranged on a respective optical channel of the plurality of optical channels. Additionally, each amplifier optical fiber of the plurality of amplifier optical fibers 108 includes one or more light-absorbing elements configured to absorb intensity-controlled pump light 122 to convert the intensity-controlled pump light 122 into a corresponding quantity of heat, thereby causing a controlled temperature within the amplifier optical fiber corresponding to an intensity of the intensity-controlled pump light.

The plurality of heater pump light sources 118 may be respectively coupled to the plurality of amplifier optical fibers 108. Thus, each heater pump light source of the plurality of heater pump light sources 118 may inject the intensity-controlled pump light 122 into a respective amplifier optical fiber of the plurality of amplifier optical fibers 108 for regulating the controlled temperature within the respective amplifier optical fiber. Additionally, the plurality of amplifying pump light sources 120 may be respectively coupled to the plurality of amplifier optical fibers 108. Thus, each amplifying pump light source of the plurality of amplifying pump light sources 120 is configured to inject amplifying pump light 124 into a respective amplifier optical fiber of the plurality of amplifier optical fibers 108 for amplifying a respective beamlet of the plurality of beamlets,

The beam combiner 110 may combine the plurality of amplified beamlets 109 into a coherently-combined amplified beam 111 for output from the coherent beam combiner system 100B.

In some implementations, the plurality of amplifying pump light sources 120 may generate the amplifying pump light 124 at a first wavelength. In addition, the plurality of heater pump light sources 118 may the intensity-controlled pump light 122 at a second wavelength that is different from the first wavelength. Each amplifier optical fiber of the plurality of amplifier optical fibers 108 may include a core and first dopants arranged in the core, the first dopants configured to absorb the first wavelength, and not absorb the second wavelength, for converting the amplifying pump light 124 into a stimulated emission for amplifying the respective beamlet. For example, the first dopants may be rare-earth element dopants. Additionally, each amplifier optical fiber of the plurality of amplifier optical fibers 108 may include second dopants (e.g., light-absorbing elements or opto-thermal conversion elements) configured to absorb the second wavelength, and not absorb the first wavelength, for converting the intensity-controlled pump light into a corresponding quantity of heat.

The plurality of heater pump light sources 118 may inject the intensity-controlled pump light 122 into the plurality of amplifier optical fibers 108 at respective intensities such that corresponding pulses of the plurality of amplified beamlets 109 have matched arrival times at the beam combiner 110. Additionally, or alternatively, the plurality of heater pump light sources 118 may inject the intensity-controlled pump light 122 into the plurality of amplifier optical fibers 108 at respective intensities such that the plurality of amplified beamlets 109 have a matched phase at the beam combiner 110. Thus, each amplifier optical fiber of the plurality of amplifier optical fibers 108 may induce a temperature-controlled delay on a respective amplified beamlet of the plurality of amplified beamlets 109 based on the controlled temperature within the amplifier optical fiber.

The controller 116 may be a feedback controller configured to individually control the intensity of the intensity-controlled pump light 122 from each heater pump light source of the plurality of heater pump light sources 118 such that corresponding pulses of the plurality of amplified beamlets 109 are phase-aligned with matched arrival times at the beam combiner 110. For example, the feedback beam splitter 112 may split a feedback portion 113 of the coherently-combined amplified beam 111 from an output path. The photodetector 114 may convert the feedback portion 113 into an electrical measurement signal (e.g., a voltage). In some implementations, the photodetector 114 may be part of the controller 116. The controller 116 may receive the feedback portion or a measurement value thereof, and adjust one or more intensities of the intensity-controlled pump light 122 from the plurality of heater pump light sources 118 such that corresponding pulses of the plurality of amplified beamlets 109 are phase-aligned with matched arrival times at the beam combiner 110. The controller 116 may also control the amplifying pump light sources 120.

As indicated above, FIG. 1B is provided merely as an example. Other examples may differ from what is described with regard to FIG. 1B.

FIG. 1C shows a coherent beam combiner system 100C according to one or more embodiments. The coherent beam combiner system 100C may be similar to the coherent beam combiner system 100B described in connection with FIG. 1B, except the plurality of amplifying pump light sources 120 may be used for amplification (e.g., amplifying the beamlets) and for thermal delay control within the amplifier optical fibers 108. Thus, the plurality of heater pump light sources 118 may be omitted from the coherent beam combiner system 100C, and an intensity of the amplifying pump light 124 may be respectively controlled to control the temperature within the amplifier optical fibers 108 and to induce temperature-controlled delays within the amplifier optical fibers 108. In other words, the amplifying pump light 124 is used as intensity-controlled pump light.

According, each amplifier optical fiber of the plurality of amplifier optical fibers 108 includes one or more light-absorbing elements configured to absorb intensity-controlled pump light (e.g., amplifying pump light 124) to convert the intensity-controlled pump light into a corresponding quantity of heat, thereby causing a controlled temperature within the amplifier optical fiber corresponding to an intensity of the intensity-controlled pump light. The plurality of amplifying pump light sources 120 may be respectively coupled to the plurality of amplifier optical fibers 108, with each pump light source being configured to inject the intensity-controlled pump light into a respective amplifier optical fiber of the plurality of amplifier optical fibers 108 for amplifying a respective beamlet of the plurality of beamlets 105 and for regulating the controlled temperature within the respective amplifier optical fiber 108.

Each amplifier optical fiber of the plurality of amplifier optical fibers 108 may include a core, a cladding, first dopants arranged in the core, and second dopants arranged in the cladding. The first dopants may be configured to absorb the intensity-controlled pump light for converting the intensity-controlled pump light into a stimulated emission for amplifying a respective beamlet 105. Additionally, the second dopants may be configured to absorb the intensity-controlled pump light for converting the intensity-controlled pump light into a corresponding quantity of heat.

Based on the optical feedback received from the feedback beam splitter 112, the controller 116 may individually control the intensity of the intensity-controlled pump light from each amplifying pump light source of the plurality of amplifying pump light sources 120 such that corresponding pulses of the plurality of amplified beamlets 109 are phase-aligned with matched arrival times at the beam combiner 110.

Using amplifier pump modulation directly for delay control may lead to varying output intensities among beamlets, resulting in reduced recombination efficiency and increased intensity noise. However, in certain scenarios, where a limited tuning range is sufficient, amplifier pump modulation may be used directly for delay control due for reducing complexity of the system. For example, amplifier pump modulation may be used directly for phase delay control when group delay is mechanically tightly constrained or fixed by other means, and only phase delay is needed. In continuous-wave coherent beam combining no group delay compensation is needed. Thus, amplifier pump modulation may be used directly for delay control for continuous wave applications. In other words, in some implementations, the seed light source 102 of the coherent beam combiner system 100C may generate continuous-wave seed light instead of pulsed seed light. Using amplifier pump modulation directly for delay control may require large pump currents (several amperes) to be controlled with high accuracy and speed.

As indicated above, FIG. 1C is provided merely as an example. Other examples may differ from what is described with regard to FIG. 1C.

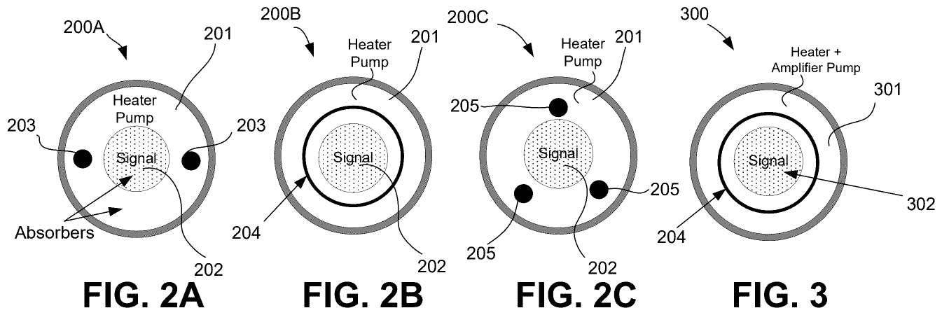

FIG. 2A shows a cross-section of a thermal delay optical fiber 200A according to one or more implementations. The thermal delay optical fiber 200A may correspond to one of the thermal delay optical fibers 106 described above in connection with FIG. 1A. Thus, the thermal delay optical fiber 200A may be used for thermal delay control in a coherent beam combining system for ultra-fast laser pulses.

The thermal delay optical fiber 200A may include a cladding 201 (e.g., a pump cladding) for guiding pump light and a core 202 for guiding signal light (e.g., a respective beamlet 105). Intensity-controlled pump light (e.g., heater pump light) may be injected into the cladding 201. Dopants (absorbers) may be distributed within the cladding 201 or within the core 202, and may be configured to absorb the wavelength of the intensity-controlled pump light to convert the intensity-controlled pump light into heat. In other words, the intensity-controlled pump light may reflect within the thermal delay optical fiber 200A and interact with the dopants to generate a control quantity of heat that corresponds to an intensity of the intensity-controlled pump light.

Additionally, or alternatively, the thermal delay optical fiber 200A may include one or more polarization-maintaining stress rods 203 arranged within the cladding 201 of the thermal delay optical fiber 200A. The polarization-maintaining stress rods may be doped with dopants (e.g., absorbents) configured to absorb the wavelength of the intensity-controlled pump light to convert the intensity-controlled pump light into heat. The polarization-maintaining stress rods 203 may be evenly distributed around the core 202 such that a homogeneous heat distribution is realized around the core 202, which may provide more accurate and consistent delay control within the thermal delay optical fiber 200A. While only two polarization-maintaining stress rods 203 are shown in FIG. 2A, three or more polarization-maintaining stress rods 203 may be provided, with an increasing number of polarization-maintaining stress rods 203 providing a more homogeneous heat distribution around the core 202 (e.g., a more homogeneous temperature profile in the thermal delay optical fiber 200A).

To maintain transparency for the signal light, dopants should not absorb the signal wavelength and should not be located outside a signal perimeter. Fastest response times are achieved when a heat source (e.g., the absorbers) is confined to a target region near the core 202. Thus, the heat source should be provided sufficiently close to the core 202 to accurately change a temperature of the core 202 to a desired temperature to effect a desired change in refractive index and, hence, a desired delay.

The polarization-maintaining stress rods 203 arranged in the thermal delay optical fiber 200A may create a controlled birefringence, for example, by controlling (e.g., limiting or preventing) mechanical stress in the thermal delay optical fiber 200A. The polarization-maintaining stress rods 203 may limit deformations or bending in the thermal delay optical fiber 200A, thereby controlling birefringence in the thermal delay optical fiber 200A to maintain a polarization orientation of the signal light. Accordingly, external polarization matching via external waveplate arrays can be avoided.

As indicated above, FIG. 2A is provided merely as an example. Other examples may differ from what is described with regard to FIG. 2A.

FIG. 2B shows a cross-section of a thermal delay optical fiber 200B according to one or more implementations. The thermal delay optical fiber 200B may correspond to one of the thermal delay optical fibers 106 described above in connection with FIG. 1A. Thus, the thermal delay optical fiber 200B may be used for thermal delay control in a coherent beam combining system for ultra-fast laser pulses.

The thermal delay optical fiber 200B may include a cladding 201 (e.g., a pump cladding) for guiding pump light and a core 202 for guiding signal light (e.g., a respective beamlet 105). Intensity-controlled pump light (e.g., heater pump light) may be injected into the cladding 201. Dopants (absorbers) may be distributed within the cladding 201 or within the core 202, and may be configured to absorb the wavelength of the intensity-controlled pump light to convert the intensity-controlled pump light into heat.

Additionally, or alternatively, the thermal delay optical fiber 200B may include an absorber ring 204 arranged within the cladding 201 of the thermal delay optical fiber 200B and encircling the core 202 of the thermal delay optical fiber 200B. The absorber ring 204 may be doped with dopants (absorbents) configured to absorb the wavelength of the intensity-controlled pump light to convert the intensity-controlled pump light into heat. The absorber ring 204 may provide a homogeneous temperature profile within the thermal delay optical fiber 200B due to being evenly distributed around the core 202. A homogeneous temperature profile may provide more accurate and consistent delay control within the thermal delay optical fiber 200B.

As indicated above, FIG. 2B is provided merely as an example. Other examples may differ from what is described with regard to FIG. 2B. In some implementations, polarization-maintaining stress rods 203 may be included in the thermal delay optical fiber 200B.

FIG. 2C shows a cross-section of a thermal delay optical fiber 200C according to one or more implementations. The thermal delay optical fiber 200C may correspond to one of the thermal delay optical fibers 106 described above in connection with FIG. 1A. Thus, the thermal delay optical fiber 200C may be used for thermal delay control in a coherent beam combining system for ultra-fast laser pulses.

The thermal delay optical fiber 200C may include a cladding 201 (e.g., a pump cladding) for guiding pump light and a core 202 for guiding signal light (e.g., a respective beamlet 105). Intensity-controlled pump light (e.g., heater pump light) may be injected into the cladding 201. Dopants (absorbents) may be distributed within the cladding 201 or within the core 202, and may be configured to absorb the wavelength of the intensity-controlled pump light to convert the intensity-controlled pump light into heat.

Additionally, or alternatively, the thermal delay optical fiber 200C may include absorber rods 205 arranged within the cladding 201 of the thermal delay optical fiber 200C, the absorber rods 205 being doped with dopants (absorbents) configured to absorb the wavelength of the intensity-controlled pump light to convert the intensity-controlled pump light into heat. The absorber rods 205 may be evenly distributed around the core 202 such that a homogeneous heat distribution is realized around the core 202, which may provide more accurate and consistent delay control within the thermal delay optical fiber 200C.

As indicated above, FIG. 2C is provided merely as an example. Other examples may differ from what is described with regard to FIG. 2C. In some implementations, polarization-maintaining stress rods 203 and/or the absorber ring 204 may be included in the thermal delay optical fiber 200C.

FIG. 3 shows a cross-section of an amplifier optical fiber 300 with thermal delay functionality according to one or more implementations. The amplifier optical fiber 300 may correspond to one of the amplifier optical fibers 108 described above in connection with FIGS. 1B and 1C.

The amplifier optical fiber 300 may include a cladding 301 (e.g., a pump cladding) for guiding pump light (e.g., intensity-controlled pump light and amplifying pump light), and a core 302 for guiding and amplifying signal light (e.g., a respective beamlet 105). First dopants may be provided in the core 302 for amplifying the signal light. For example, the first dopants may absorb a wavelength for the amplifying pump light to converting the amplifying pump light into a stimulated emission for amplifying the respective beamlet. Second dopants may be provided in the cladding 201 and/or the core 202, and may be configured to absorb the wavelength of the intensity-controlled pump light to convert the intensity-controlled pump light into heat.

In some implementations, the amplifier optical fiber 300 may include the absorber ring 204, as shown in FIG. 3. Additionally, or alternatively, the amplifier optical fiber 300 may include stress rods or absorber rods.

In some implementations, the first dopants and the second dopants may be different for absorbing different wavelengths of light, as is the case for FIG. 1B. In some implementations, the first dopants and the second dopants may be the same for absorbing a same wavelength of light, as may be the case for FIG. 1C.

As indicated above, FIG. 3 is provided merely as an example. Other examples may differ from what is described with regard to FIG. 3.

The following provides an overview of some Aspects of the present disclosure:

Aspect 1: A coherent beam combining system, comprising: a seed light source configured to generate pulsed seed light comprising a plurality of pulses; a beam splitter configured to split the pulsed seed light into a plurality of beamlets, and provide the plurality of beamlets to a plurality of optical channels, wherein each beamlet of the plurality of beamlets is provided to a respective optical channel of the plurality of optical channels; a plurality of thermal delay optical fibers, wherein each thermal delay optical fiber of the plurality of thermal delay optical fibers is arranged on a respective optical channel of the plurality of optical channels, wherein each thermal delay optical fiber of the plurality of thermal delay optical fibers includes one or more light-absorbing elements configured to absorb intensity-controlled pump light to convert the intensity-controlled pump light into a corresponding quantity of heat, thereby causing a controlled temperature within the thermal delay optical fiber corresponding to an intensity of the intensity-controlled pump light; a plurality of heater pump light sources respectively coupled to the plurality of thermal delay optical fibers, wherein each heater pump light source of the plurality of heater pump light sources is configured to inject the intensity-controlled pump light into a respective thermal delay optical fiber of the plurality of thermal delay optical fibers for regulating the controlled temperature within the respective thermal delay optical fiber; a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels; and a beam combiner configured to combine the plurality of amplified beamlets into a combined amplified beam.

Aspect 2: The coherent beam combining system of Aspect 1, wherein the seed light source is configured to generate the pulsed seed light at a first wavelength, wherein the plurality of heater pump light sources are configured to generate the intensity-controlled pump light at a second wavelength that is different from the first wavelength, and wherein the one or more light-absorbing elements are configured to absorb the second wavelength and not absorb the first wavelength.

Aspect 3: The coherent beam combining system of Aspect 2, wherein the one or more light-absorbing elements are dopants distributed within a cladding or within a core of the thermal delay optical fiber, the dopants being configured to absorb the second wavelength.

Aspect 4: The coherent beam combining system of Aspect 2, wherein the one or more light-absorbing elements are polarization-maintaining stress rods arranged within a cladding of the thermal delay optical fiber, the polarization-maintaining stress rods being doped with dopants configured to absorb the second wavelength.

Aspect 5: The coherent beam combining system of Aspect 2, wherein the one or more light-absorbing elements includes an absorber ring arranged within a cladding of the thermal delay optical fiber and encircling a core of the thermal delay optical fiber, the absorber ring being doped with dopants configured to absorb the second wavelength.

Aspect 6: The coherent beam combining system of Aspect 2, wherein the one or more light-absorbing elements are absorber rods arranged within a cladding of the thermal delay optical fiber, the absorber rods being doped with dopants configured to absorb the second wavelength.

Aspect 7: The coherent beam combining system of any of Aspects 1-6, wherein the plurality of heater pump light sources are configured to inject the intensity-controlled pump light into the plurality of thermal delay optical fibers at respective intensities such that corresponding pulses of the plurality of amplified beamlets have matched arrival times at the beam combiner.

Aspect 8: The coherent beam combining system of any of Aspects 1-7, wherein the plurality of heater pump light sources are configured to inject the intensity-controlled pump light into the plurality of thermal delay optical fibers at respective intensities such that the plurality of amplified beamlets have a matched phase at the beam combiner.

Aspect 9: The coherent beam combining system of any of Aspects 1-8, wherein the plurality of heater pump light sources are configured to inject the intensity-controlled pump light into the plurality of thermal delay optical fibers at respective intensities such that the plurality of amplified beamlets combine with a substantially maximum constructive interference at the beam combiner.

Aspect 10: The coherent beam combining system of any of Aspects 1-9, wherein the plurality of thermal delay optical fibers are arranged upstream from the plurality of amplifier optical fibers, wherein the plurality of thermal delay optical fibers are configured to: guide the plurality of beamlets from the beam splitter to the plurality of amplifier optical fibers; and thermally-control phases and time delays of the plurality of beamlets such that corresponding pulses of the plurality of amplified beamlets are phase-aligned with matched arrival times at the beam combiner.

Aspect 11: The coherent beam combining system of Aspect 10, wherein each thermal delay optical fiber of the plurality of thermal delay optical fibers is configured to induce a controlled delay on a respective beamlet of the plurality of beamlets based on the controlled temperature within the thermal delay optical fiber.

Aspect 12: The coherent beam combining system of any of Aspects 1-11, wherein the plurality of thermal delay optical fibers are arranged downstream from the plurality of amplifier optical fibers, wherein the plurality of thermal delay optical fibers are configured to: guide the plurality of amplified beamlets from the plurality of amplifier optical fibers to the beam combiner; and thermally-control phases and time delays of the plurality of amplified beamlets such that corresponding pulses of the plurality of amplified beamlets are phase-aligned with matched arrival times at the beam combiner.

Aspect 13: The coherent beam combining system of Aspect 12, wherein each thermal delay optical fiber of the plurality of thermal delay optical fibers is configured to induce a controlled delay on a respective amplified beamlet of the plurality of amplified beamlets based on the controlled temperature within the thermal delay optical fiber.

Aspect 14: The coherent beam combining system of any of Aspects 1-13, further comprising: a feedback controller configured to individually control the intensity of the intensity-controlled pump light from each heater pump light source of the plurality of heater pump light sources such that corresponding pulses of the plurality of amplified beamlets are phase-aligned with matched arrival times at the beam combiner.

Aspect 15: The coherent beam combining system of Aspect 14, further comprising: a feedback beam splitter configured to split a feedback portion of the combined amplified beam from an output path, wherein the feedback controller is configured receive the feedback portion and adjust one or more intensities of the intensity-controlled pump light from the plurality of heater pump light sources such that corresponding pulses of the plurality of amplified beamlets are phase-aligned with matched arrival times at the beam combiner.

Aspect 16: A coherent beam combining system, comprising: a seed light source configured to generate pulsed seed light comprising a plurality of pulses; a beam splitter configured to split the pulsed seed light into a plurality of beamlets, and provide the plurality of beamlets to a plurality of optical channels, wherein each beamlet of the plurality of beamlets is provided to a respective optical channel of the plurality of optical channels; a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels, and wherein each amplifier optical fiber of the plurality of amplifier optical fibers includes one or more light-absorbing elements configured to absorb intensity-controlled pump light to convert the intensity-controlled pump light into a corresponding quantity of heat, thereby causing a controlled temperature within the amplifier optical fiber corresponding to an intensity of the intensity-controlled pump light; a plurality of heater pump light sources respectively coupled to the plurality of amplifier optical fibers, wherein each heater pump light source of the plurality of heater pump light sources is configured to inject the intensity-controlled pump light into a respective amplifier optical fiber of the plurality of amplifier optical fibers for regulating the controlled temperature within the respective amplifier optical fiber; and a beam combiner configured to combine the plurality of amplified beamlets into a combined amplified beam.

Aspect 17: The coherent beam combining system of Aspect 16, further comprising: a plurality of amplifying pump light sources respectively coupled to the plurality of amplifier optical fibers, wherein each amplifying pump light source of the plurality of amplifying pump light sources is configured to inject amplifying pump light into a respective amplifier optical fiber of the plurality of amplifier optical fibers for amplifying a respective beamlet of the plurality of beamlets.

Aspect 18: The coherent beam combining system of Aspect 17, wherein the plurality of amplifying pump light sources are configured to generate the amplifying pump light at a first wavelength, wherein the plurality of heater pump light sources are configured to generate the intensity-controlled pump light at a second wavelength that is different from the first wavelength, wherein each amplifier optical fiber of the plurality of amplifier optical fibers includes a core and first dopants arranged in the core, the first dopants configured to absorb the first wavelength, and not absorb the second wavelength, for converting the amplifying pump light into a stimulated emission for amplifying the respective beamlet, and wherein each amplifier optical fiber of the plurality of amplifier optical fibers includes second dopants configured to absorb the second wavelength, and not absorb the first wavelength, for converting the intensity-controlled pump light into the corresponding quantity of heat.

Aspect 19: The coherent beam combining system of any of Aspects 16-18, wherein the plurality of heater pump light sources are configured to inject the intensity-controlled pump light into the plurality of amplifier optical fibers at respective intensities such that corresponding pulses of the plurality of amplified beamlets have matched arrival times at the beam combiner.

Aspect 20: The coherent beam combining system of any of Aspects 16-19, wherein the plurality of heater pump light sources are configured to inject the intensity-controlled pump light into the plurality of amplifier optical fibers at respective intensities such that the plurality of amplified beamlets have a matched phase at the beam combiner.

Aspect 21: The coherent beam combining system of any of Aspects 16-20, wherein each amplifier optical fiber of the plurality of amplifier optical fibers is configured to induce a controlled delay on a respective amplified beamlet of the plurality of amplified beamlets based on the controlled temperature within the amplifier optical fiber.

Aspect 22: A coherent beam combining system, comprising: a seed light source configured to generate seed light; a beam splitter configured to split the seed light into a plurality of beamlets, and provide the plurality of beamlets to a plurality of optical channels, wherein each beamlet of the plurality of beamlets is provided to a respective optical channel of the plurality of optical channels; a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels, and wherein each amplifier optical fiber of the plurality of amplifier optical fibers includes one or more light-absorbing elements configured to absorb intensity-controlled pump light to convert the intensity-controlled pump light into a corresponding quantity of heat, thereby causing a controlled temperature within the amplifier optical fiber corresponding to an intensity of the intensity-controlled pump light; a plurality of pump light sources respectively coupled to the plurality of amplifier optical fibers, wherein each pump light source of the plurality of pump light sources is configured to inject the intensity-controlled pump light into a respective amplifier optical fiber of the plurality of amplifier optical fibers for amplifying a respective beamlet of the plurality of beamlets and for regulating the controlled temperature within the respective amplifier optical fiber; and a beam combiner configured to combine the plurality of amplified beamlets into a combined amplified beam.

Aspect 23: The coherent beam combining system of Aspect 22, wherein each amplifier optical fiber of the plurality of amplifier optical fibers includes a core, a cladding, first dopants arranged in the core, and second dopants arranged in the cladding, wherein the first dopants are configured to absorb the intensity-controlled pump light for converting the intensity-controlled pump light into a stimulated emission for amplifying the respective beamlet, and wherein the second dopants are configured to absorb the intensity-controlled pump light for converting the intensity-controlled pump light into the corresponding quantity of heat.

Aspect 24: The coherent beam combining system of any of Aspects 22-23, further comprising: a feedback controller configured to individually control the intensity of the intensity-controlled pump light from each pump light source of the plurality of pump light sources such that corresponding pulses of the plurality of amplified beamlets are phase-aligned with matched arrival times at the beam combiner.

Aspect 25: The coherent beam combining system of Aspect 24, further comprising: a feedback beam splitter configured to split a feedback portion of the combined amplified beam from an output path, wherein the feedback controller is configured receive the feedback portion and adjust one or more intensities of the intensity-controlled pump light from the plurality of pump light sources such that corresponding pulses of the plurality of amplified beamlets are phase-aligned with matched arrival times at the beam combiner.

Aspect 26: The coherent beam combining system of Aspect 22, wherein the seed light is continuous-wave seed light.

Aspect 27: A system configured to perform one or more operations recited in one or more of Aspects 1-26.

Aspect 28: An apparatus comprising means for performing one or more operations recited in one or more of Aspects 1-26.

Aspect 29: A non-transitory computer-readable medium storing a set of instructions, the set of instructions comprising one or more instructions that, when executed by a device, cause the device to perform one or more operations recited in one or more of Aspects 1-26.

Aspect 30: A computer program product comprising instructions or code for executing one or more operations recited in one or more of Aspects 1-26.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A coherent beam combining system, comprising:
a seed light source configured to generate pulsed seed light comprising a plurality of pulses;
a beam splitter configured to split the pulsed seed light into a plurality of beamlets, and provide the plurality of beamlets to a plurality of optical channels, wherein each beamlet of the plurality of beamlets is provided to a respective optical channel of the plurality of optical channels;
a plurality of thermal delay optical fibers, wherein each thermal delay optical fiber of the plurality of thermal delay optical fibers is arranged on a respective optical channel of the plurality of optical channels, wherein each thermal delay optical fiber of the plurality of thermal delay optical fibers includes one or more light-absorbing elements configured to absorb intensity-controlled pump light to convert the intensity-controlled pump light into a corresponding quantity of heat, thereby causing a controlled temperature within the thermal delay optical fiber corresponding to an intensity of the intensity-controlled pump light;
a plurality of heater pump light sources respectively coupled to the plurality of thermal delay optical fibers, wherein each heater pump light source of the plurality of heater pump light sources is configured to inject the intensity-controlled pump light into a respective thermal delay optical fiber of the plurality of thermal delay optical fibers for regulating the controlled temperature within the respective thermal delay optical fiber;
a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels; and
a beam combiner configured to combine the plurality of amplified beamlets into a coherently-combined amplified beam.

2. The coherent beam combining system of claim 1, wherein the seed light source is configured to generate the pulsed seed light at a first wavelength,
wherein the plurality of heater pump light sources are configured to generate the intensity-controlled pump light at a second wavelength that is different from the first wavelength, and
wherein the one or more light-absorbing elements are configured to absorb the second wavelength and not absorb the first wavelength.

3. The coherent beam combining system of claim 2, wherein the one or more light-absorbing elements are dopants distributed within a cladding or within a core of a thermal delay optical fiber, the dopants being configured to absorb the second wavelength.

4. The coherent beam combining system of claim 2, wherein the one or more light-absorbing elements are polarization-maintaining stress rods arranged within a cladding of a thermal delay optical fiber, the polarization-maintaining stress rods being doped with dopants configured to absorb the second wavelength.

5. The coherent beam combining system of claim 2, wherein the one or more light-absorbing elements includes an absorber ring arranged within a cladding of a thermal delay optical fiber and encircling a core of the thermal delay optical fiber, the absorber ring being doped with dopants configured to absorb the second wavelength.

6. The coherent beam combining system of claim 2, wherein the one or more light-absorbing elements are absorber rods arranged within a cladding of a thermal delay optical fiber, the absorber rods being doped with dopants configured to absorb the second wavelength.

7. The coherent beam combining system of claim 1, wherein the plurality of heater pump light sources are configured to inject the intensity-controlled pump light into the plurality of thermal delay optical fibers at respective intensities such that corresponding pulses of the plurality of amplified beamlets have matched arrival times at the beam combiner.

8. The coherent beam combining system of claim 1, wherein the plurality of heater pump light sources are configured to inject the intensity-controlled pump light into the plurality of thermal delay optical fibers at respective intensities such that the plurality of amplified beamlets have a matched phase at the beam combiner.

9. The coherent beam combining system of claim 1, wherein the plurality of heater pump light sources are configured to inject the intensity-controlled pump light into the plurality of thermal delay optical fibers at respective intensities such that the plurality of amplified beamlets combine with a substantially maximum constructive interference at the beam combiner.

10. The coherent beam combining system of claim 1, wherein the plurality of thermal delay optical fibers are arranged upstream from the plurality of amplifier optical fibers, wherein the plurality of thermal delay optical fibers are configured to:
guide the plurality of beamlets from the beam splitter to the plurality of amplifier optical fibers; and
thermally-control phases and time delays of the plurality of beamlets such that corresponding pulses of the plurality of amplified beamlets are phase-aligned with matched arrival times at the beam combiner.

11. The coherent beam combining system of claim 10, wherein each thermal delay optical fiber of the plurality of thermal delay optical fibers is configured to induce a controlled delay on a respective beamlet of the plurality of beamlets based on the controlled temperature within the thermal delay optical fiber.

12. The coherent beam combining system of claim 1, wherein the plurality of thermal delay optical fibers are arranged downstream from the plurality of amplifier optical fibers, wherein the plurality of thermal delay optical fibers are configured to:
guide the plurality of amplified beamlets from the plurality of amplifier optical fibers to the beam combiner; and
thermally-control phases and time delays of the plurality of amplified beamlets such that corresponding pulses of the plurality of amplified beamlets are phase-aligned with matched arrival times at the beam combiner.

13. The coherent beam combining system of claim 12, wherein each thermal delay optical fiber of the plurality of thermal delay optical fibers is configured to induce a controlled delay on a respective amplified beamlet of the plurality of amplified beamlets based on the controlled temperature within the thermal delay optical fiber.

14. The coherent beam combining system of claim 1, further comprising:
a feedback controller configured to individually control the intensity of the intensity-controlled pump light from each heater pump light source of the plurality of heater pump light sources such that corresponding pulses of the plurality of amplified beamlets are phase-aligned with matched arrival times at the beam combiner.

15. The coherent beam combining system of claim 14, further comprising:
a feedback beam splitter configured to split a feedback portion of the coherently-combined amplified beam from an output path,
wherein the feedback controller is configured receive the feedback portion and adjust one or more intensities of the intensity-controlled pump light from the plurality of heater pump light sources such that corresponding pulses of the plurality of amplified beamlets are phase-aligned with matched arrival times at the beam combiner.

16. A coherent beam combining system, comprising:
a seed light source configured to generate pulsed seed light comprising a plurality of pulses;
a beam splitter configured to split the pulsed seed light into a plurality of beamlets, and provide the plurality of beamlets to a plurality of optical channels, wherein each beamlet of the plurality of beamlets is provided to a respective optical channel of the plurality of optical channels;
a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels, and wherein each amplifier optical fiber of the plurality of amplifier optical fibers includes one or more light-absorbing elements configured to absorb intensity-controlled pump light to convert the intensity-controlled pump light into a corresponding quantity of heat, thereby causing a controlled temperature within the amplifier optical fiber corresponding to an intensity of the intensity-controlled pump light;
a plurality of heater pump light sources respectively coupled to the plurality of amplifier optical fibers, wherein each heater pump light source of the plurality of heater pump light sources is configured to inject the intensity-controlled pump light into a respective amplifier optical fiber of the plurality of amplifier optical fibers for regulating the controlled temperature within the respective amplifier optical fiber; and
a beam combiner configured to combine the plurality of amplified beamlets into a coherently-combined amplified beam.

17. The coherent beam combining system of claim 16, further comprising:
a plurality of amplifying pump light sources respectively coupled to the plurality of amplifier optical fibers, wherein each amplifying pump light source of the plurality of amplifying pump light sources is configured to inject amplifying pump light into a respective amplifier optical fiber of the plurality of amplifier optical fibers for amplifying a respective beamlet of the plurality of beamlets.

18. The coherent beam combining system of claim 17, wherein the plurality of amplifying pump light sources are configured to generate the amplifying pump light at a first wavelength,
wherein the plurality of heater pump light sources are configured to generate the intensity-controlled pump light at a second wavelength that is different from the first wavelength,
wherein each amplifier optical fiber of the plurality of amplifier optical fibers includes a core and first dopants arranged in the core, the first dopants configured to absorb the first wavelength, and not absorb the second wavelength, for converting the amplifying pump light into a stimulated emission for amplifying the respective beamlet of the plurality of beamlets, and
wherein each amplifier optical fiber of the plurality of amplifier optical fibers includes second dopants configured to absorb the second wavelength, and not absorb the first wavelength, for converting the intensity-controlled pump light into the corresponding quantity of heat.

19. The coherent beam combining system of claim 16, wherein the plurality of heater pump light sources are configured to inject the intensity-controlled pump light into the plurality of amplifier optical fibers at respective intensities such that corresponding pulses of the plurality of amplified beamlets have matched arrival times at the beam combiner.

20. The coherent beam combining system of claim 16, wherein the plurality of heater pump light sources are configured to inject the intensity-controlled pump light into the plurality of amplifier optical fibers at respective intensities such that the plurality of amplified beamlets have a matched phase at the beam combiner.

21. The coherent beam combining system of claim 16, wherein each amplifier optical fiber of the plurality of amplifier optical fibers is configured to induce a controlled delay on a respective amplified beamlet of the plurality of amplified beamlets based on the controlled temperature within the amplifier optical fiber.

22. A coherent beam combining system, comprising:
a seed light source configured to generate seed light;
a beam splitter configured to split the seed light into a plurality of beamlets, and provide the plurality of beamlets to a plurality of optical channels, wherein each beamlet of the plurality of beamlets is provided to a respective optical channel of the plurality of optical channels;
a plurality of amplifier optical fibers configured to amplify the plurality of beamlets to generate a plurality of amplified beamlets, wherein each amplifier optical fiber of the plurality of amplifier optical fibers is arranged on a respective optical channel of the plurality of optical channels, and wherein each amplifier optical fiber of the plurality of amplifier optical fibers includes one or more light-absorbing elements configured to absorb intensity-controlled pump light to convert the intensity-controlled pump light into a corresponding quantity of heat, thereby causing a controlled temperature within the amplifier optical fiber corresponding to an intensity of the intensity-controlled pump light;
a plurality of pump light sources respectively coupled to the plurality of amplifier optical fibers, wherein each pump light source of the plurality of pump light sources is configured to inject the intensity-controlled pump light into a respective amplifier optical fiber of the plurality of amplifier optical fibers for amplifying a respective beamlet of the plurality of beamlets and for regulating the controlled temperature within the respective amplifier optical fiber; and
a beam combiner configured to combine the plurality of amplified beamlets into a coherently-combined amplified beam.

23. The coherent beam combining system of claim 22,
wherein each amplifier optical fiber of the plurality of amplifier optical fibers includes a core, a cladding, first dopants arranged in the core, and second dopants arranged in the cladding,
wherein the first dopants are configured to absorb the intensity-controlled pump light for converting the intensity-controlled pump light into a stimulated emission for amplifying the respective beamlet of the plurality of beamlets, and
wherein the second dopants are configured to absorb the intensity-controlled pump light for converting the intensity-controlled pump light into the corresponding quantity of heat.

24. The coherent beam combining system of claim 22, further comprising:
a feedback controller configured to individually control the intensity of the intensity-controlled pump light from each pump light source of the plurality of pump light sources such that corresponding pulses of the plurality of amplified beamlets are phase-aligned with matched arrival times at the beam combiner,
wherein the seed light is pulsed seed light comprising a plurality of pulses.

25. The coherent beam combining system of claim 24, further comprising:
a feedback beam splitter configured to split a feedback portion of the coherently-combined amplified beam from an output path,
wherein the feedback controller is configured receive the feedback portion and adjust one or more intensities of the intensity-controlled pump light from the plurality of pump light sources such that corresponding pulses of the plurality of amplified beamlets are phase-aligned with matched arrival times at the beam combiner.

26. The coherent beam combining system of claim 22, wherein the seed light is continuous-wave seed light.
